(19) United States
(12) Patent Application Publication
(10) Pub. No.: US 2023/0169565 A1
(43) Pub. Date: Jun. 1, 2023

(54) SYSTEMS AND METHODS FOR GENERATING SEASONAL AND THEME-AWARE RECOMMENDATIONS

(71) Applicant: Walmart Apollo, LLC, Bentonville, AR (US)

(72) Inventors: Luyi Ma, Sunnyvale, CA (US); Nimesh Sinha, San Jose, CA (US); Parth Ramesh Vajge, Sunnyvale, CA (US); Hyun Duk Cho, San Francisco, CA (US); Sushant Kumar, San Jose, CA (US); Kannan Achan, Saratoga, CA (US)

(21) Appl. No.: 17/536,885

(22) Filed: Nov. 29, 2021

(51) Int. Cl. G06Q 30/06; G06Q 30/02

(52) U.S. Cl. CPC G06Q 30/0631; G06Q 30/0201; G06Q 30/0252

(57) ABSTRACT

A seasonal recommendation system can include a computing device that is configured to receive a request to identify a set of recommendations associated with a season, obtain historical data over a threshold period for a set of product types, and compute a seasonality index score based on the historical data over a target period and the threshold period. The computing device is also configured to select a subset of product types based on the seasonality index score and by applying a theme-aware model to the product types and identify and store a set of items corresponding to at least one product type of the subset of product types. The computing device is configured to, in response to a user navigating to a webpage using a user device, select and display at least one item of the set of items on a user interface of the user device.

### TECHNICAL FIELD

The disclosure relates generally to systems and methods for generating seasonal recommendations and more particularly to recommending items based on query-product type interactions.

### BACKGROUND

Customers and potential customers navigate to ecommerce websites to search for particular items for purchase. Oftentimes, customers are searching for a specific item or list of items. Ecommerce platforms are presented with the opportunity to display any particular items of interest on various webpages the user may navigate through or to when searching for items for purchase.

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

The embodiments described herein are directed to a seasonal recommendation system and related methods. The seasonal recommendation system can include a computing device that is configured to receive a request to identify a set of recommendations associated with a season and obtain historical data over a threshold period for a set of product types. The computing device is further configured to, for each product type of the set of product types, compute a seasonality index score based on the historical data over a target period and the threshold period, the target period being a portion of the threshold period. The computing device is also configured to select a subset of product types based on the seasonality index score and by applying a theme-aware model to the product types and identify and store a set of items corresponding to at least one product type of the subset of product types. The computing device is configured to, in response to a user navigating to a webpage using a user device, select and display at least one item of the set of items on a user interface of the user device.

In another aspect, the computing device is configured to select a first threshold number of product types based on the seasonality index score and apply the theme-aware model to the selected first threshold number of product types to select the subset of product types. In another aspect, the computing device is configured to compute an item seasonality index score for each item of the subset of product types and identify the set of items as a second threshold number of items corresponding to a highest item seasonality index score.

In another aspect, the theme-aware model is generated by obtaining a set of queries and corresponding items linked to at least one query of the set of queries and applying an iterative clustering algorithm to the set of queries and the items to cluster the queries of the set of queries and the items. In another aspect, the theme-aware model is generated by generating a theme-aware dataset based on a computed click-through-rate for each item and building the theme-aware model using the theme-aware dataset.

In another aspect, the set of queries are selected based on the season.

In another aspect, the target period is associated with the season.

In another aspect, the request is automatically generated and transmitted to the computing device in response to the season being within a threshold time of a present time.

In another aspect, the historical data includes a number of transactions for each item and each item is associated with a product type of the set of product types.

In another aspect, the item seasonality index score is computed based on a yearly item seasonality index score, the yearly item seasonality index score being computed as, for each year of the threshold period, a number of transactions corresponding to a first item of the product type during the target period divided by a number of transaction corresponding to the first item of the product type during the corresponding year of the threshold period.

In another aspect, the item seasonality index score is an average of the yearly item seasonality index score for each year of the threshold period.

In various embodiments of the present disclosure, a method of seasonal recommendations is provided. In some embodiments, the method can include receiving a request to identify a set of recommendations associated with a season and obtaining historical data over a threshold period for a set of product types. The method is further includes, for each product type of the set of product types, computing a seasonality index score based on the historical data over a target period and the threshold period, the target period being a portion of the threshold period. The method also includes selecting a subset of product types based on the seasonality index score and by applying a theme-aware model to the product types and identifying and storing a set of items corresponding to at least one product type of the subset of product types. The method includes, in response to a user navigating to a webpage using a user device, selecting and displaying at least one item of the set of items on a user interface of the user device.

In various embodiments of the present disclosure, a non-transitory computer readable medium is provided. The non-transitory computer readable medium can have instructions stored thereon, wherein the instructions, when executed by at least one processor, cause a device to perform operations that include receiving a request to identify a set of recommendations associated with a season and obtaining historical data over a threshold period for a set of product types. The operations include, for each product type of the set of product types, computing a seasonality index score based on the historical data over a target period and the threshold period, the target period being a portion of the threshold period. The operations also include selecting a subset of product types based on the seasonality index score and by applying a theme-aware model to the product types and identifying and storing a set of items corresponding to at least one product type of the subset of product types. The operations include, in response to a user navigating to a webpage using a user device, selecting and displaying at least one item of the set of items on a user interface of the user device.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The features and advantages of the present disclosures will be more fully disclosed in, or rendered obvious by, the following detailed descriptions of example embodiments. The detailed descriptions of the example embodiments are to be considered together with the accompanying drawings wherein like numbers refer to like parts and further wherein:

FIG. 1 is a block diagram of a seasonal recommendation system in accordance with some embodiments;

FIG. 2 is a block diagram of a computing device implementing the seasonal recommendation device of FIG. 1 in accordance with some embodiments;

FIG. 3 is a graphical user interface depicting example seasonal recommended items for display on an ecommerce marketplace in accordance with some embodiments;

FIG. 4 is a block diagram illustrating an example seasonal recommendation module of the seasonal recommendation system of FIG. 1 in accordance with some embodiments;

FIG. 5 is a block diagram illustrating an example theme model generation module of the seasonal recommendation system of FIG. 1 in accordance with some embodiments;

FIGS. 6A and 6B are flowcharts of example methods of generation of seasonal item recommendations in accordance with some embodiments;

FIG. 7 is a flowchart of example methods of theme-based product type filtration in accordance with some embodiments; and

FIG. 8 is a flowchart of examples methods of seasonal item recommendation retrieval and display in accordance with some embodiments.

In the drawings, reference numbers may be reused to identify similar and/or identical elements.

### DETAILED DESCRIPTION

The description of the preferred embodiments is intended to be read in connection with the accompanying drawings, which are to be considered part of the entire written description of these disclosures. While the present disclosure is susceptible to various modifications and alternative forms, specific embodiments are shown by way of example in the drawings and will be described in detail herein. The objectives and advantages of the claimed subject matter will become more apparent from the following detailed description of these exemplary embodiments in connection with the accompanying drawings.

It should be understood, however, that the present disclosure is not intended to be limited to the particular forms disclosed. Rather, the present disclosure covers all modifications, equivalents, and alternatives that fall within the spirit and scope of these exemplary embodiments. The terms “couple,” “coupled,” “operatively coupled,” “connected,” “operatively connected,” and the like should be broadly understood to refer to connecting devices or components together either mechanically, electrically, wired, wirelessly, or otherwise, such that the connection allows the pertinent devices or components to operate (e.g., communicate) with each other as intended by virtue of that relationship.

A seasonal recommendation system may be implemented to generate a set of recommended items based on the season. For example, a customer navigating to an ecommerce website associated with a particular entity may be presented with items related to the time of year or a particular holiday, event, etc., associated with the present time of year. In various implementations, the seasonal recommendations may be independent of historical customer recommendations based on the customer’s search and/or transaction history. The seasonal recommendation system may display particular items related to, for example, the winter, spring, summer, or fall season based on the present time of year. Additionally or alternatively, the seasonal recommendation system may display particular items based on a proximity to a particular holiday or event, such as Halloween, Thanksgiving, Christmas, the Super Bowl, etc. The seasonal recommendation system may recommend explicit seasons, such as winter, spring, summer, and fall as well as implicit seasons, such as holidays (Valentine’s Day, Halloween, etc.) or events (Super Bowl, March Madness, etc.). The seasonal recommendation system provides additional opportunities to sellers that sell specific seasonal products, increases views of relevant seasonal items and purchase of relevant seasonal items, measures impact of purchases of items during specific seasons, improves customer experience by providing relevant items and reminding customers of upcoming seasons, etc.

To identify a set of items corresponding to a particular season, holiday, and/or event, the seasonal recommendation system compares transaction or purchase history of product types to identify peak purchase times throughout the year across a plurality of years. For example, the seasonal recommendation system identifies which product types, such as party supplies, greeting cards, nightwear, women’s clothing, etc., have the highest number of transactions during a time period identified to correspond to the target season (e.g., Christmas, Mother’s Day, etc.). Depending on the type of target season, the seasonal recommendation system may have a preset time period that may extend over four months (for example, the fall season), a month (for example, Christmas), a week (for, example, Halloween), etc. Based on the predetermined time period, the seasonal recommendation system identifies, over the predetermined, corresponding time period, the product types with the highest number of transactions, for example, the seasonal recommendation system may identify the top five product types with the highest number of transactions. In various implementations, the seasonal recommendation system may average transactions over the time period for a previous number of years, such as the last three years.

Additionally, since some product types may be included in the product types with the highest number of transactions simply due to the time over which the time period corresponds (for example, humidifier purchases may coincide with a time period corresponding to Valentine’s Day), the seasonal recommendation system applies a machine learning model that is theme aware to filter out any themes that do not correspond to or are not associated with the target season. That is, the machine learning models that are theme aware are able to filter out, in the above example, humidifiers when the target season is Valentine’s Day.

The seasonal recommendation system can further identify items within the product types with a highest number of transactions to narrow the items that are specifically displayed to customers during the particular time period. In various implementations, additional parameters may be considered for displayed particular product types or items to customers on an ecommerce website, such as item selections, add to cart selections, etc.

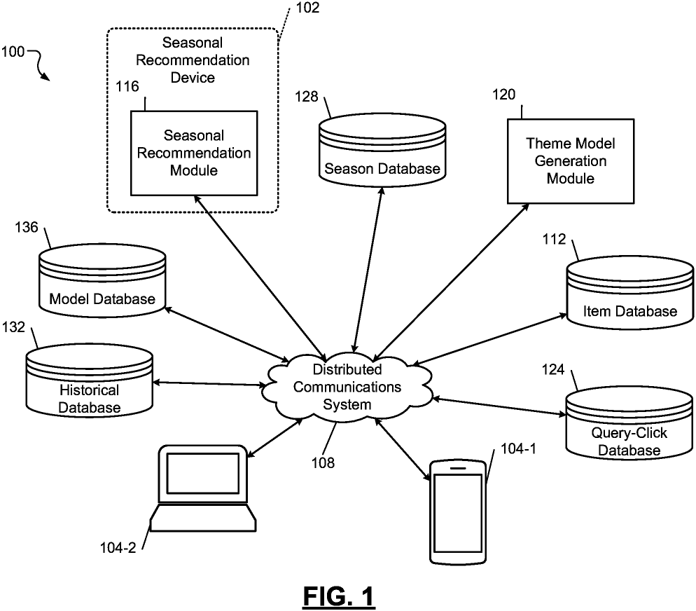

Referring to FIG. 1, a block diagram of a seasonal recommendation system 100 is shown. The seasonal recommendation system 100 may include a seasonal recommendation device 102 and user devices 104-1 and 104-2, collectively user device 104, such as a phone, tablet, laptop, mobile computing device, desktop, etc., capable of communicating with a plurality of databases and modules via a distributed communications system 108. The user device 104 may display an ecommerce marketplace via a web browser or an application for customers to view items for sale by the ecommerce marketplace that are stored in an item database 112. For example, a customer may browse a webpage being display on a graphical user interface of the user device 104 and/or submit a query through the graphical user interface of the user device 104 on the ecommerce marketplace through a web browser or application, which retrieves a subset of items from the item database 112 that pertain to the query and displays the subset of items to the customer via the graphical user interface of the user device 104.

The seasonal recommendation system 100 also includes a training seasonal recommendation module 116 and a theme model generation module 120. The seasonal recommendation system 100 also includes a query-click database 124, a season database 128, a historical database 132, and a model database 136. The item database 112 stores items for sale on the ecommerce marketplace, and the items are categorized by product type. That is, each item may have a corresponding product type to which the item belongs. For example, product types may be greeting cards, chocolate candies, rings, gift baskets, party supplies, decorations, etc. Then, there are items categorized into the product types, for example, decorations may include items that are posters, plaques and signs, photographic art, art prints, etc.

The historical database 132 may store historical transactions over a plurality of past years for each of the items in the item database 112. For example, for the last three years, the historical database 132 includes a number of purchases for each item on each day of the previous number of years. In this way, the seasonal recommendation module 116 may access the historical transaction data stored in the historical database 132 to identify, for a particular season, which product types, as indexed by item in the item database 112, which product types have the highest recorded transactions during the particular time period corresponding to the particular season. For example, the season database 128 may store predetermined seasons (fall, summer, Christmas, etc.) along with the time period corresponding to that season. For example, for Christmas, the predetermined time period may be the two months preceding December 25. The seasonal recommendation module 116 may identify, for the last three years, which product types have the most transactions in the historical database during the particular season (e.g., the two months preceding Christmas).

The theme model generation module 120 may implement machine learning, such as iterative clustering, of query-click data to training a model to become theme aware. For example, the query-click database 124 stores data indicating which items’ product types were selected by a customer as a result of a customer submitting particular queries. That is, based on user selected of a particular item, the product type corresponding to the item is indicated. Using the linking data, the theme model generation module can identify themes corresponding to particular seasons by tracking items and/or product types selected as a result of theme-related queries. For example, theme-related queries may be queries including the terms identifying the season, such as the term “Christmas” or “fall.”

Once the linked queries and product types are identified from data stored in the query-click database 124, the theme model generation module 120 performs iterative clustering to group queries and product types until no new clusters form. From the clustered queries and product types, the theme model generation module 120 may compute an estimated click-through rate for each product type cluster. Based on the estimated click-through rate, the theme model generation module 120 can identify the top product type clusters related to each “theme” that corresponds to the seasons. Using the clusters and generated related data, the theme model generation module 120 can build a theme-aware model for the particular season to filter out any product types not related to the particular season.

The generated model for each season may be stored in the model database 136 and implemented by the seasonal recommendation module 116 to filter the identified top product types to remove any products unrelated to the particular season. The seasonal recommendation module 116 may identify specific items of the filtered product types that have had the highest number of transactions during the time period corresponding to the particular season. For example, the seasonal recommendation module 116 may select the top five items with the highest historical number (on average) of transactions over the time period corresponding to the particular season. The highest number may be stored in the season database 128 as corresponding to the particular season. In various implementations, the entity operating the ecommerce website may continually collect historical transaction information and store the collected information in the historical database 132 and collect query-click data to store in the query-click database 124.

Moreover, the seasonal recommendation device 102 may implement the seasonal recommendation module 116 in anticipation of each season stored in the season database 128 to ensure the most up-to-date historical transaction data is used to identify the most relevant or most purchased items for the season. When a customer navigates to the ecommerce website, the present date is identified and the stored top items (from the season database 128) may be obtained and displayed in a particular area of the ecommerce user interface to display those items to the customer.

The seasonal recommendation device 102 and the user device 104 can be any suitable computing device that includes any hardware or hardware and software combination for processing and handling information. For example, the term “device” and/or “module” can include one or more processors, one or more field-programmable gate arrays (FPGAs), one or more application-specific integrated circuits (ASICs), one or more state machines, digital circuitry, or any other suitable circuitry. In addition, each can transmit data to, and receive data from, the distributed communications system 108. In various implementations, the devices, modules, and databases may communicate directly on an internal network.

As indicated above, the seasonal recommendation device 102 and/or the user device 104 can be a computer, a workstation, a laptop, a server such as a cloud-based server, or any other suitable device. In some examples, seasonal recommendation device 102 and/or the user device 104 can be a cellular phone, a smart phone, a tablet, a personal assistant device, a voice assistant device, a digital assistant, a laptop, a computer, or any other suitable device. In various implementations, the seasonal recommendation device 102 is on a central computing system that is operated and/or controlled by a retailer. Additionally or alternatively, the modules and databases of the seasonal recommendation device 102 are distributed among one or more workstations or servers that are coupled together over the distributed communications system 108.

The databases described can be remote storage devices, such as a cloud-based server, a memory device on another application server, a networked computer, or any other suitable remote storage. Further, in some examples, the databases can be a local storage device, such as a hard drive, a non-volatile memory, or a USB stick.

The distributed communications system 108 can be a WiFi® network, a cellular network such as a 3GPP® network, a Bluetooth® network, a satellite network, a wireless local area network (LAN), a network utilizing radio-frequency (RF) communication protocols, a Near Field Communication (NFC) network, a wireless Metropolitan Area Network (MAN) connecting multiple wireless LANs, a wide area network (WAN), or any other suitable network. The distributed communications system 108 can provide access to, for example, the Internet.

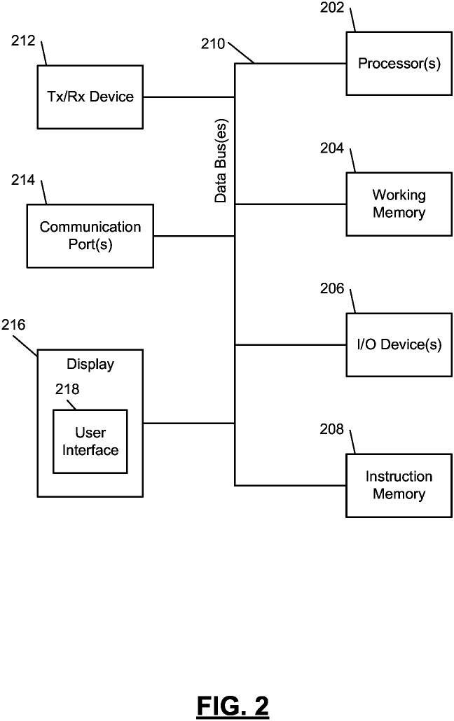

FIG. 2 illustrates an example computing device 200. The seasonal recommendation device 102 and/or the user device 104 may include the features shown in FIG. 2. For the sake of brevity, FIG. 2 is described relative to the seasonal recommendation device 102.

As shown, the seasonal recommendation device 102 can be a computing device 200 that may include one or more processors 202, working memory 204, one or more input/output devices 206, instruction memory 208, a transceiver 212, one or more communication ports 214, and a display 216, all operatively coupled to one or more data buses 210. Data buses 210 allow for communication among the various devices. Data buses 210 can include wired, or wireless, communication channels.

Processors 202 can include one or more distinct processors, each having one or more cores. Each of the distinct processors can have the same or different structure. Processors 202 can include one or more central processing units (CPUs), one or more graphics processing units (GPUs), application specific integrated circuits (ASICs), digital signal processors (DSPs), and the like.

Processors 202 can be configured to perform a certain function or operation by executing code, stored on instruction memory 208, embodying the function or operation. For example, processors 202 can be configured to perform one or more of any function, method, or operation disclosed herein.

Instruction memory 208 can store instructions that can be accessed (e.g., read) and executed by processors 202. For example, instruction memory 208 can be a non-transitory, computer-readable storage medium such as a read-only memory (ROM), an electrically erasable programmable read-only memory (EEPROM), flash memory, a removable disk, CD-ROM, any non-volatile memory, or any other suitable memory.

Processors 202 can store data to, and read data from, working memory 204. For example, processors 202 can store a working set of instructions to working memory 204, such as instructions loaded from instruction memory 208. Processors 202 can also use working memory 204 to store dynamic data created during the operation of the seasonal recommendation device 102. Working memory 204 can be a random access memory (RAM) such as a static random access memory (SRAM) or dynamic random access memory (DRAM), or any other suitable memory.

Input-output devices 206 can include any suitable device that allows for data input or output. For example, input-output devices 206 can include one or more of a keyboard, a touchpad, a mouse, a stylus, a touchscreen, a physical button, a speaker, a microphone, or any other suitable input or output device.

Communication port(s) 214 can include, for example, a serial port such as a universal asynchronous receiver/transmitter (UART) connection, a Universal Serial Bus (USB) connection, or any other suitable communication port or connection. In some examples, communication port(s) 214 allows for the programming of executable instructions in instruction memory 208. In some examples, communication port(s) 214 allow for the transfer (e.g., uploading or downloading) of data, such as data items including feedback information.

Display 216 can display a user interface 218. User interfaces 218 can enable user interaction with the seasonal recommendation device 102. For example, user interface 218 can be a user interface that allows an operator to select and browse items via the ecommerce website or marketplace. The user interface 218 can, for example, display the items for sale for a user or customer view as a result of searching or browsing on an ecommerce marketplace. In some examples, display 216 can be a touchscreen, where user interface 218 is displayed on the touchscreen.

Transceiver 212 allows for communication with a network, such as the distributed communications system 108 of FIG. 1. For example, if the distributed communications system 108 of FIG. 1 is a cellular network, transceiver 212 is configured to allow communications with the cellular network. In some examples, transceiver 212 is selected based on the type of distributed communications system 108 in which the seasonal recommendation device 102 will be operating. Processor(s) 202 is operable to receive data from, or send data to, a network, such as the distributed communications system 108 of FIG. 1, via transceiver 212.

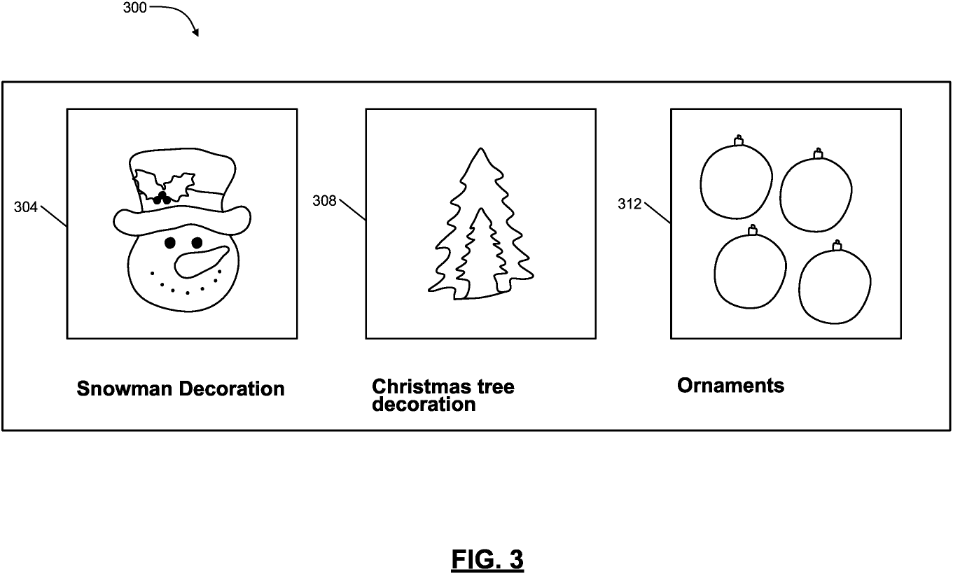

Referring now to FIG. 3, a graphical user interface 300 depicting example seasonal recommended items for display on an ecommerce marketplace is shown. For example, the seasonal recommendation device 102, discussed above, may recommend a number of items identified at most highly purchased during a time period associated with, for example, Christmas. As shown in FIG. 3, on a portion of the user interface of the ecommerce website may display a snowman decoration 304, a Christmas tree decoration 308, and ornaments 312. A customer may select one of the display items to purchase or view additional information about the item.

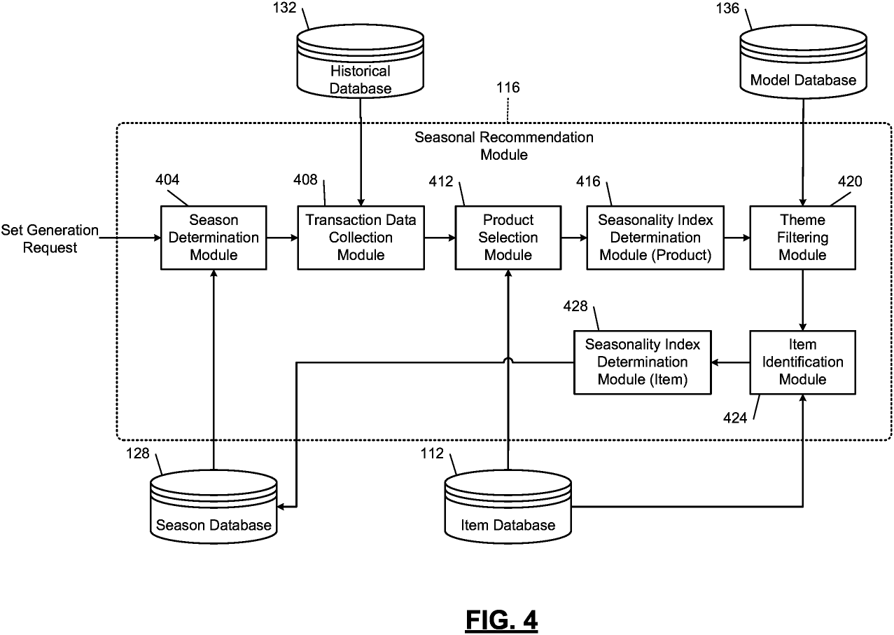

Referring now to FIG. 4, a block diagram illustrating an example seasonal recommendation module of the seasonal recommendation system is shown. The seasonal recommendation module 116 includes a season determination module 404 which receives a set generation request. For example, an analyst associated with the entity operating the ecommerce marketplace may specifically submit a set generation request in anticipation of a particular season started. In various implementations, the seasonal recommendation device 102 automatically generates and submits a set generation request indicating a particular season that is presently approached to identify which items to display for the approaching season. The season determination module 404 parses the set generation request to identify which season is indicated in the set generation request. The season determination module 404 obtains parameters for the indicated season from the season database 128, including a time period associated with the indicated season.

Once the time period is obtained from the season database 128, the time period and the season are forwarded to a transaction data collection module 408. The transaction data collection module 408 obtains historical transaction data from the historical database 132 over the time period associated with the indicated season for a number of past years, for example, the last three years. The obtained historical transaction data is forwarded to a product selection module 412. The product selection module 412 obtains relationship data from the item database 112 indicating which items belong to each product type.

The obtained historical transaction data and product type data is forwarded to a seasonality index determination module 416 (by product). The seasonality index determination module 416 computes a seasonality index score by product type based on the historical transaction data obtained for the season’s time period. The seasonality index determination module 416 computes the number of transactions for each product type over the time period for each previous year of historical transaction data (previously obtained from the historical database 132. The seasonality index determination module 416 also determines the total number of transactions for each product type in each year.

Then, the seasonality index score may be the historical number of transactions of the product during the time period divided by the number of transactions for that product type during the year. Further, the seasonality index score is a mean of the determined scores across the number of years of historical transaction data. From the seasonality index scores for each product type, the top number of product types are selected. For example, the top five product types are selected.

The top product types (e.g., those product types with the highest seasonality score) are forwarded to a theme filtering module 420. The theme filtering module 420 selects a season model from the model database 136 corresponding to the season indicated in the set generation request. The season model identifies which of the top product types correspond to the theme associated with the season and removes any product types that do not correspond to the season’s theme. The filtered product types are forwarded to an item identification module 424, which identifies which items are included in the filtered product types. The identified items are forwarded to a seasonality index determination module 428 (by item) determines the seasonality index scores for each item of the filtered product types. The seasonality index determination module 428 identifies the top (for example, five) items or rather those items with the highest seasonality index scores. Those top items are then stored in the season database 128 corresponding to the season indicated in the set generation request. Then, those top items may be obtained from the season database 128 to be displayed on the ecommerce website prior to as well as during the time period of the season.

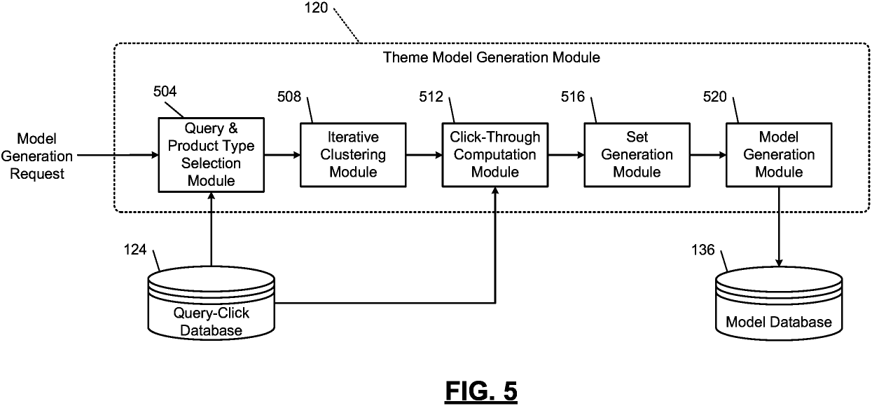

Referring now to FIG. 5, a block diagram illustrating an example theme model generation module of the seasonal recommendation system is shown. The theme model generation module 120 includes a query and product type selection module 504 that receives a model generation request. In various implementations, the model generation request occurs at threshold intervals, for example, in anticipation of a particular season occurring. The query and product type selection module 504 obtains query-click data from the query-click database 124 corresponding to a season indicated in the model generation request. For example, the query and product type selection module 504 obtains data for those queries that include particular terms salient to the indicated season. For example, the name of the season (e.g., “Christmas”) and other terms known to be specifically related to the indicated season. As noted previously, the data obtained includes those product types (which are mapped from selected items indicated in the query-click data) that have been selected as a result of the particular queries. In various implementations, the query and product type selection module 504 may obtain the query-click data indicating particular items and map those items to a product type to which the item is categorized. For example, the query and product type selection module 504 obtains the query-click data that identifies those items that a customer selected as a result of submitting the query “Christmas,” and maps those items to the particular product type to which they belong.

The query and product type selection module 504 forwards the obtained data from the iterative clustering module 508. In various implementations, the iterative clustering module 508 receives the query and product type informative as a bipartite graph (or as two separate types of information that are capable of being clustered together). The iterative clustering module 508 may treat each query and product type cluster as a “dummy” nodes for clustering. The iterative clustering module 508 applies a clustering algorithm on both the query and product type nodes to rebuild feature vectors until no new clusters are formed. The clustered nodes are forwarded to a click-through computation module 512. The click-through computation module 512 calculates a click-through rate for each product type cluster. The click-through rate indicates how frequently one of the product types of the product type cluster is selected as a ratio to how often the corresponding item of that product type is displayed to a customer. In various implementations, the query-click database 124 may also store data used to compute the click-through rate, including a number of times items of the particular product type are displayed to customers as a result of the corresponding query as well as a number of times an item of the particular product type is selected.

The click-through rate for each product type in the product type clusters is forwarded to a set generation module 516 which generates a training data set by selecting the product types with the highest click to display ratio, indicating which product types are most frequently selected when displayed to a customer as a result of a query being submitted that is associated with the indicated season. In various implementations, the set generation module 516 may include the top five product types with the highest click-through rate. The generated set of training data that is indicated as most season or theme aware is forwarded to a model generation module 520, which may use the generated set as training data to create a model for the indicated season. The generated model is stored in the model database 136.

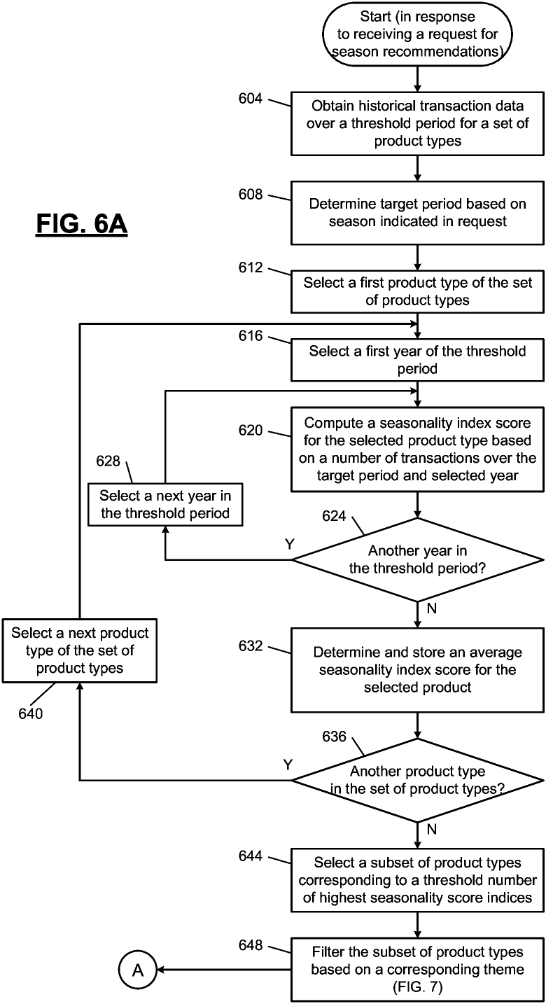

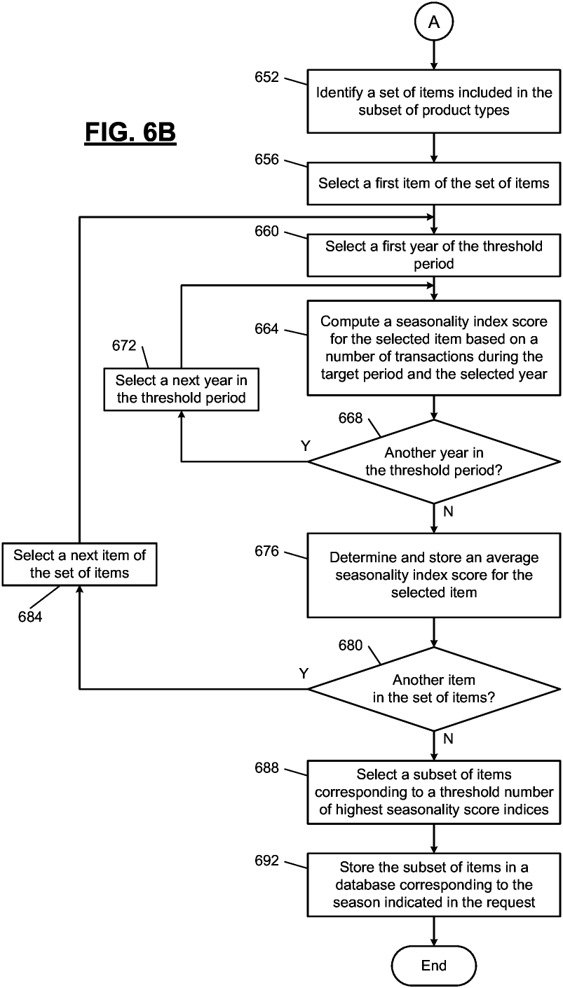

Referring now to FIGS. 6A and 6B, flowcharts of example methods of generation of seasonal item recommendations are shown. Control begins in response to receiving a request for seasonal recommendations. For example, at predetermined intervals, the seasonal recommendation system may automatically prompt the system to generate seasonal recommendations to be stored in a database for the system to access and display to customers. The predetermined intervals may be in anticipation of a particular season, for example a week, a month, etc., prior to the beginning of the season. In various implementations, the stored recommendations may be access by the system to generate and send promotional emails to particular customers, displaying those items that are most relevant to the upcoming or present season.

Control continues to 604 to obtain historical transaction data over a threshold period for a set of product types. For example, the threshold period may be the last three years. Control proceeds to 608 to determine a target period based on the season indicated in the request. In various implementations, the target period is indicated in a database as associated with a season indicated in the request. Control continues to 612 to select a first product type of the set of product types. Control continues to 616 to select a first year of the threshold period. Control proceeds to 620 to compute a seasonality index score for the selected product type based on a number of transactions during the target period and during the corresponding year. Control continues to 624 to determine if another year is in the threshold period. If yes, control continues to 628 to select a next year in the threshold period and returns to 620. Otherwise control proceeds to 632 to determine and store an average seasonality index score for the selected product type.

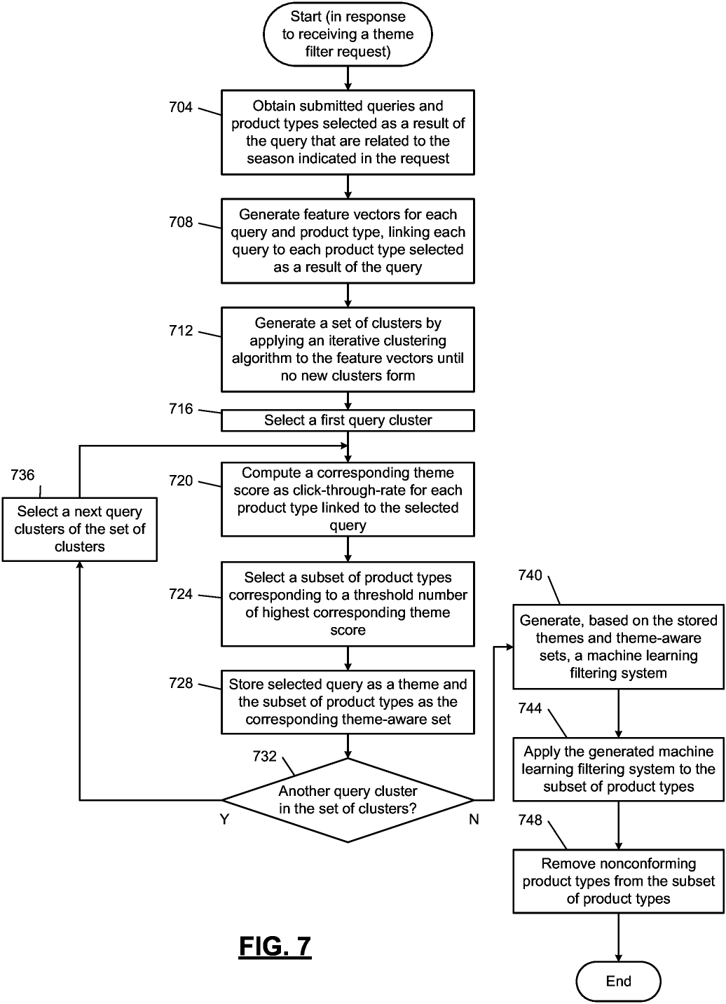

Control continues to 636 to determine if another product type is in the set of product types. If yes, control continues to 640 to select a next product type of the set of product types and returns to 616. Otherwise, control proceeds to 644 to select a subset of product types corresponding to a threshold number of the highest seasonality score indices. That is, the product types with the top seasonality score indices are included in the subset, for example, the top five product types. Control continues to 648 to filter the subset of product types based on a corresponding theme associated with the season indicated in the request (described in the flowchart of FIG. 7).

In FIG. 6B, control continues to 652 to identify a set of items included in the subset of product types. At 656, control selects a first item of the set of items. Control continues to 660 to select a first year of the threshold period. At 664, control computes a seasonality index score for the selected item based on a number of transactions during the target period and over the selected year. Control continues to 668 to determine if another year is in the threshold period. If yes, control continues to 672 to select a next year in the threshold period and returns to 664. Otherwise, control continues to 676 to determine and store an average seasonality index score for the selected item. Control continues to 680 to determine if another item is in the set of items. If yes, control proceeds to 684 to select a next item of the set of items and returns to 660. Otherwise, control continues to 688 to select a subset of items corresponding to a threshold number of the items with the highest seasonality score indices, for example, the top five. Control continues to 692 to store the subset of items in a database corresponding to the season indicated in the request. Then, control ends.

Referring now to FIG. 7, a flowchart of example methods of theme-based product type filtration is shown. Control begins in response to receiving a theme filter request, shown in step 648 of FIG. 6A. Control continues to 704 to obtain submitted queries and product types selected as a result of the query that are related to the season indicated in the request. For example, queries may be determined to be related to the season indicated in the request if the query includes particular salient terms. Control continues to 708 to generate feature vectors for each query and product types, linking each query to each product type of each item selected as a result of the query. For example, each query and product type may be represented as a node.

Control continues to 712 to generate a set of clusters by applying an iterative clustering algorithm to the feature vectors until no new clusters form. Control continues to 716 to select a first query cluster. Control proceeds to 720 to compute a corresponding theme score as a click-through-rate for each item of the product type linked to the selected query. For example, the click-through-rate, as discussed above, may be estimated for each of the product types linked to the query cluster and then estimated for the query, the query indicating a theme. Control continues to 724 to select a subset of product types corresponding to a threshold number of the highest corresponding theme scores (highest click-through-rate). Control continues to 728 to store the selected query as a theme and the subset of product types as the corresponding theme-aware set. Control continues to 732 to determine if another query cluster is in the set of clusters. If yes, control continues to 736 to select a next query cluster of the set of query clusters and returns to 720.

Otherwise, control continues to 740 to generate, based on the stored themes and theme-aware sets, which are related to the indicated season, a machine learning filtering system. The stored themes and theme-aware sets may be training data to train the machine learning filtering system to identify whether a particular product type belongs to or should be classified as belonging to the theme. Control proceeds to 744 to apply the generate machine learning filtering system to the subset of product types. Control continues to 748 to remove nonconforming product types from the subset of product types. Then, control ends.

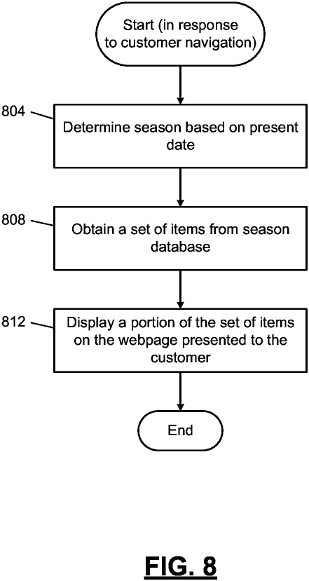

Referring now to FIG. 8, a flowchart of examples methods of seasonal item recommendation retrieval and display is shown. Control begins in response to customer navigation, for example, any customer selection on an ecommerce marketplace interface. Control continues to 804 to determine a season based on the present date. Control continues to 808 to obtain a set of items from a season database based on the season. Then, at 812, control displays a portion of the set of items on the webpage presented to the customer. Then, control ends. As mentioned previously, in various implementations, control may identify and select a set of items based on a season and generate and transmit emails to customers displaying the set of items based on the season.

Although the methods described above are with reference to the illustrated flowcharts, it will be appreciated that many other ways of performing the acts associated with the methods can be used. For example, the order of some operations may be changed, and some of the operations described may be optional.

In addition, the methods and system described herein can be at least partially embodied in the form of computer-implemented processes and apparatus for practicing those processes. The disclosed methods may also be at least partially embodied in the form of tangible, non-transitory machine-readable storage media encoded with computer program code. For example, the steps of the methods can be embodied in hardware, in executable instructions executed by a processor (e.g., software), or a combination of the two. The media may include, for example, RAMs, ROMs, CD-ROMs, DVD-ROMs, BD-ROMs, hard disk drives, flash memories, or any other non-transitory machine-readable storage medium. When the computer program code is loaded into and executed by a computer, the computer becomes an apparatus for practicing the method. The methods may also be at least partially embodied in the form of a computer into which computer program code is loaded or executed, such that, the computer becomes a special purpose computer for practicing the methods. When implemented on a general-purpose processor, the computer program code segments configure the processor to create specific logic circuits. The methods may alternatively be at least partially embodied in application specific integrated circuits for performing the methods.

The term model as used in the present disclosure includes data models created using machine learning. Machine learning may involve training a model in a supervised or unsupervised setting. Machine learning can include models that may be trained to learn relationships between various groups of data. Machine learned models may be based on a set of algorithms that are designed to model abstractions in data by using a number of processing layers. The processing layers may be made up of non-linear transformations. The models may include, for example, artificial intelligence, neural networks, deep convolutional and recurrent neural networks. Such neural networks may be made of up of levels of trainable filters, transformations, projections, hashing, pooling and regularization. The models may be used in large-scale relationship-recognition tasks. The models can be created by using various open-source and proprietary machine learning tools known to those of ordinary skill in the art.

The foregoing is provided for purposes of illustrating, explaining, and describing embodiments of these disclosures. Modifications and adaptations to these embodiments will be apparent to those skilled in the art and may be made without departing from the scope or spirit of these disclosures.

What is claimed is:

1. A system comprising:
a computing device configured to:
receive a request to identify a set of recommendations associated with a season;
obtain historical data over a threshold period for a set of product types;
for each product type of the set of product types, compute a seasonality index score based on the historical data over a target period and the threshold period, the target period being a portion of the threshold period;
select a subset of product types based on the seasonality index score and by applying a theme-aware model to the product types;
identify and store a set of items corresponding to at least one product type of the subset of product types; and
in response to a user navigating to a webpage using a user device, select and display at least one item of the set of items on a user interface of the user device.

2. The system of claim 1, wherein the computing device is configured to:
select a first threshold number of product types based on the seasonality index score;
apply the theme-aware model to the selected first threshold number of product types to select the subset of product types;
compute an item seasonality index score for each item of the subset of product types; and
identify the set of items as a second threshold number of items corresponding to a highest item seasonality index score.

3. The system of claim 1, wherein the theme-aware model is generated by:
obtaining a set of queries and corresponding items linked to at least one query of the set of queries;
identifying product types corresponding to each of the items;
applying an iterative clustering algorithm to the set of queries and the product types to cluster the queries of the set of queries and the product types;
generating a theme-aware dataset based on a computed click-through-rate for each product type; and
building the theme-aware model using the theme-aware dataset.

4. The system of claim 3, wherein the set of queries are selected based on the season.

5. The system of claim 1, wherein the target period is associated with the season.

6. The system of claim 1, wherein the request is automatically generated and transmitted to the computing device in response to the season being within a threshold time of a present time.

7. The system of claim 1, wherein:
the historical data includes a number of transactions for each item, and
each item is associated with a product type of the set of product types.

8. The system of claim 7, wherein the item seasonality index score is computed based on a yearly item seasonality index score, the yearly item seasonality index score being computed as, for each year of the threshold period, a number of transactions corresponding to a first item of the product type during the target period divided by a number of transaction corresponding to the first item of the product type during the corresponding year of the threshold period.

9. The system of claim 8, wherein the item seasonality index score is an average of the yearly item seasonality index score for each year of the threshold period.

10. A method comprising:
receiving a request to identify a set of recommendations associated with a season;
obtaining historical data over a threshold period for a set of product types;
for each product type of the set of product types, computing a seasonality index score based on the historical data over a target period and the threshold period, the target period being a portion of the threshold period;
selecting a subset of product types based on the seasonality index score and by applying a theme-aware model to the product types;
identifying and storing a set of items corresponding to at least one product type of the subset of product types; and
in response to a user navigating to a webpage using a user device, selecting and displaying at least one item of the set of items on a user interface of the user device.

11. The method of claim 10, further comprising:
selecting a first threshold number of product types based on the seasonality index score;
applying the theme-aware model to the selected first threshold number of product types to select the subset of product types;
computing an item seasonality index score for each item of the subset of product types; and
identifying the set of items as a second threshold number of items corresponding to a highest item seasonality index score.

12. The method of claim 10, wherein the theme-aware model is generated by:
obtaining a set of queries and corresponding items linked to at least one query of the set of queries;
identifying product types corresponding to each of the items;
applying an iterative clustering algorithm to the set of queries and the product types to cluster the queries of the set of queries and the product types;
generating a theme-aware dataset based on a computed click-through-rate for each product type; and
building the theme-aware model using the theme-aware dataset.

13. The method of claim 12, wherein the set of queries are selected based on the season.

14. The method of claim 10, wherein the target period is associated with the season.

15. The method of claim 10, further comprising automatically generating and transmitting the request in response to the season being within a threshold time of a present time.

16. The method of claim 10, wherein:
the historical data includes a number of transactions for each item, and
each item is associated with a product type of the set of product types.

17. The method of claim 16, wherein the item seasonality index score is computed based on a yearly item seasonality index score, the yearly item seasonality index score being computed as, for each year of the threshold period, a number of transactions corresponding to a first item of the product type during the target period divided by a number of transaction corresponding to the first item of the product type during the corresponding year of the threshold period.

18. The method of claim 17, wherein the item seasonality index score is an average of the yearly item seasonality index score for each year of the threshold period.

19. A non-transitory computer readable medium having instructions stored thereon, wherein the instructions, when executed by at least one processor, cause a device to perform operations comprising:
receiving a request to identify a set of recommendations associated with a season;
obtaining historical data over a threshold period for a set of product types;
for each product type of the set of product types, computing a seasonality index score based on the historical data over a target period and the threshold period, the target period being a portion of the threshold period;
selecting a subset of product types based on the seasonality index score and by applying a theme-aware model to the product types;
identifying and storing a set of items corresponding to at least one product type of the subset of product types; and
in response to a user navigating to a webpage using a user device, selecting and displaying at least one item of the set of items on a user interface of the user device.

20. The non-transitory computer-readable medium of claim 19, further comprising:
selecting a first threshold number of product types based on the seasonality index score;
applying the theme-aware model to the selected first threshold number of product types to select the subset of product types;
computing an item seasonality index score for each item of the subset of product types; and
identifying the set of items as a second threshold number of items corresponding to a highest item seasonality index score.
